(19) United States
(12) Patent Application Publication
(10) Pub. No.: US 2012/0175397 A1
(43) Pub. Date: Jul. 12, 2012

(54) FLAT-CLINCH STAPLER

(75) Inventor: Koc-Sing CO, KOWLOON (HK)

(73) Assignee: COSIMEX (H.K.) LIMITED, KOWLOON (HK)

(21) Appl. No.: 13/340,720

(22) Filed: Dec. 30, 2011

(30) Foreign Application Priority Data
Jan. 7, 2011 (CN) 201120012652.9

(51) Int. Cl. B25C 5/02; B25C 5/11

(52) U.S. Cl. 227/155

(57) ABSTRACT

The present invention relates to a kind of flat-clinch stapler comprising a staple pressing device, a staple magazine device, a base and a staple flat-clinching device whereas the staple flat-clinching device comprises a movable platform a movable platform supporting block, a movable platform position fixing block and a spring; and also comprising a push arm whereas the push arm comprises an upper fulcrum, a middle fulcrum, a blocking part, and a lower push arm.

### BACKGROUND OF THE INVENTION

The present invention relates to stapler and specifically relates to a kind of flat-clinch stapler. Stapler is a kind of equipment commonly used in offices for stapling separate sheets of material so that they are not scattered and misplaced and thus easy to keep or carry. Currently, there are many kinds of staplers and they could be generally divided into hand-operated staplers and electrically-operated staplers. Hand-operated staplers are however more common. A pile of stapled documents is not flat enough and it is also scratchy because a staple that binds the documents forms an arched shape after it is clinched using a stapler. To solve these problems, flat-clinch staplers for flat clinching are also provided in the market.

In general, a flat-clinch stapler comprises a staple pressing device, a staple magazine device, a base and a staple flat-clinching device. The staple pressing device comprises an outer cap, an inner cap disposed inside the outer cap and a staple plunger blade disposed at a front end of the inner cap. A rear end of the inner cap is pivotally connected with a rear end of the staple magazine device via a pivot. A front end of the staple magazine device is disposed with a staple plunge hole through which the first staple at the forefront of the staple magazine device is driven out of the staple magazine device. The staple flat-clinching device comprises a movable platform upwardly biased, vertically movable and accommodated in the base. The movable platform is disposed with a staple slot for a staple to pass through during the process of clinching a staple. A staple bending device is disposed at a bottom part of the staple slot disposed at the movable platform in order to flatten ends of a staple that passes through the staple slot disposed at the movable platform.

A flat-clinch stapler contains more movable parts than a general hand-operated stapler. Since there are always spaces left between movable parts, hands and fingers in between the movable parts would easily get trapped and hurt. Besides, due to the increase in number of movable parts, the flat-clinch stapler would also increase in its overall weight. As a result, it is more difficult for the flat-clinch stapler to reset its position completely after clinching a staple and it is therefore inconvenient to use the flat-clinch stapler repeatedly. Furthermore, use of the flat-clinch stapler for a long period of time would also cause hand muscles to suffer from fatigue or injury.

### BRIEF SUMMARY OF THE INVENTION

In view of the aforesaid disadvantages, it is an object of the present invention to provide a kind of flat-clinch stapler. By using a simple structure, the flat-clinch stapler according to the present invention operates a staple flat-clinching device and at the same time prevents hands and fingers of a user or other objects from getting into its inner cap and staple magazine device. User is therefore saved from injuries and the present invention is also saved from damages caused by external objects and thereby prolonging its duration of use. Besides, the present invention may also comprise an effort-saving arm to attain effort-saving effect.

In order to attain the above object, the present invention adopts the following technical proposal:

A kind of flat-clinch stapler comprising a staple pressing device, a staple magazine device, a base and a staple flat-clinching device whereas the staple flat-clinching device comprises a movable platform upwardly biased, vertically movable and accommodated in the base, a movable platform supporting block, a movable platform position fixing block fixedly provided in the base placing above the movable platform supporting block during a stationary condition to lift up the movable platform, and a spring which biases the movable platform supporting block forward; and characterized in that it also comprises a push arm whereas the push arm comprises an upper fulcrum pivotally connected with the staple pressing device, a middle fulcrum pivotally connected with the staple magazine device, a blocking part provided at a front end of the push arm covering the spaces between the staple pressing device and the staple magazine device, and a lower push arm whereas the lower push arm, while clinching a staple, contacts the sliding block of the movable platform supporting block and pushes it backward so that the movable platform supporting block is pushed to separate from the movable platform position fixing block and thereby allowing the movable platform to press downward to complete flat clinching of a staple.

The push arm comprises a left side panel and a right side panel provided on a left side and a right side of the staple magazine device respectively. The left side panel and the right side panel are mutually connected with each other at the upper fulcrum of the push arm via a first pivot pin and they are also pivotally connected with the staple pressing device.

The left side panel and the right side panel are mutually connected with each other at the middle fulcrum of the push arm via a second connecting member. A rear end of the second connecting member is disposed with a pivotal connection structure which is pivotally connected with the staple magazine device.

The staple pressing device comprises an outer cap, an inner cap disposed inside the outer cap, and a staple plunger blade disposed at a front end of the inner cap. A rear end of the inner cap is pivotally connected with a rear end of the staple magazine device via a third pivot pin.

The flat-clinch stapler according to the present invention may also comprise an effort-saving arm and a hanger. The hanger is fixedly provided between the outer cap and the base. A rear part of the inner cap is pivotally connected with a rear part of the hanger. The effort-saving arm comprises a force exertion point connected with an inner side of a front end of the outer cap at its one end, a supporting point pivotally connected with the hanger at the other end, and a pressing point pivotally connected with an upper side of the inner cap between the force exertion point and the supporting point. Ratio of distance between the third pivot pin and the pressing point and distance between the third pivot pin and the front end of the inner cap is greater than ratio of distance between the supporting point and the pressing point and distance between the supporting point and the force exertion point.

The effort-saving arm comprises a left side plate and a right side plate disposed on a left side and a right side of the inner cap respectively. The left side plate and the right side plate are connected by an upper side plate across their upper parts. A curved groove rotable on an upper surface of the inner cap is disposed on an inner side of the upper side plate at the pressing point.

The staple flat-clinching device also comprises a left staple bending member, a right staple bending member and a staple bending member stopper. The staple bending member stopper is fixedly provided in the base and it corresponds to the position of a staple plunge hole of the staple magazine device and the position of a staple slot of the movable platform. Outer ends of the left staple bending member and the right staple bending member respectively are structured to be pivotally rotable and they are pushed to rotate pivotally upward by the staple bending member stopper during the process of staple clinching to form a plane for flattening ends of a staple.

The present invention is operated as follows:

When the flat-clinch stapler is stationary, the movable platform supporting block is placed above the movable platform position fixing block and the movable platform is lifted up.

In the beginning of clinching a staple, a front end of the outer cap of the staple pressing device is pressed down and the force exertion point of the effort-saving arm is thereby driven to be pressed down; the supporting point of the effort-saving arm is then driven to rotate pivotally and the pressing point is then driven to press down the inner cap; the staple plunger blade is then driven to be pressed down to drive a staple at the forefront of the staple magazine device out from the staple plunge hole; meanwhile, the upper fulcrum of the push arm rotates pivotally along the first pivot pin and the middle fulcrum rotates pivotally along the pivotal connection structure of the second connecting member while the lower push arm is pushed backward to contact the sliding block and then pushes the sliding block backward; accordingly, the movable platform supporting block is simultaneously driven to be pushed backward until the movable platform supporting block separates from the movable platform position fixing block; at this time, the force of downward pressing exerted by user causes the movable platform to move down into the base, and the staple bending member stopper pushes the left staple bending member and the right staple bending member to rotate pivotally upward to form a plane for flattening ends of the staple and ends of the staple are then pressed against that plane to complete flat-clinching of the staple.

After clinching the staple, user stops to exert force onto the stapler and the movable platform returns to its upwardly biased position; the staple magazine device is pushed upward by a first reset device disposed between the movable platform and the staple magazine device and thereby returns to its original position while the inner cap is also pushed upward by a second reset device disposed between the inner cap and the staple magazine device and thereby returns to its original position; the upper fulcrum of the push arm then rotates pivotally along the first pivot pin and the middle fulcrum also rotates pivotally along the pivotal connection structure of the second connecting member such that the lower push arm is driven to move forward; since the force that pushes the sliding block backward disappears, the movable platform supporting block is pushed forward by the spring to returns to its original position and again placed above the movable platform position fixing block to prevent the movable platform from moving downward.

Compared with the prior art, the push arm according to the present invention could be used to operate the staple flat-clinching device, also, it is disposed with a blocking part to prevent hands and fingers of a user or other objects from getting into the spaces between the inner cap and the staple magazine device. By using a simple structure, the present invention performs the above two functions simultaneously with simpler manufacturing procedures and lower costs. Besides, configuration of an additional effort-saving arm could also attain effort-saving effect.

### BRIEF DESCRIPTION OF THE DRAWINGS

FIG. 1 illustrates the schematic structure of the present invention according to an embodiment when the present invention is stationary.

FIG. 2 illustrates the schematic structure of the present invention according to an embodiment when the present invention is clinching a staple.

FIG. 3 illustrates a 3-dimensional view of the present invention according to an embodiment.

FIG. 4 is an exploded view showing different parts of the present invention according to an embodiment.

FIG. 5 illustrates a 3-dimensional view of a push arm of the present invention according to an embodiment.

FIG. 6 illustrates a 3-dimensional view of an effort-saving arm of the present invention according to an embodiment.

### DETAILED DESCRIPTION OF THE INVENTION

The present invention is further described in detail below with reference to an embodiment and the accompanying drawings, but the present invention is not limited to the description therein.

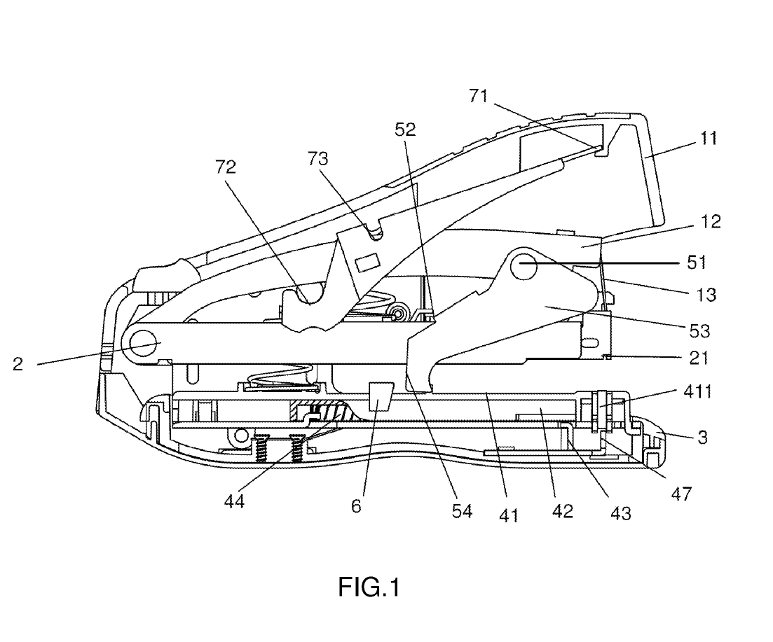

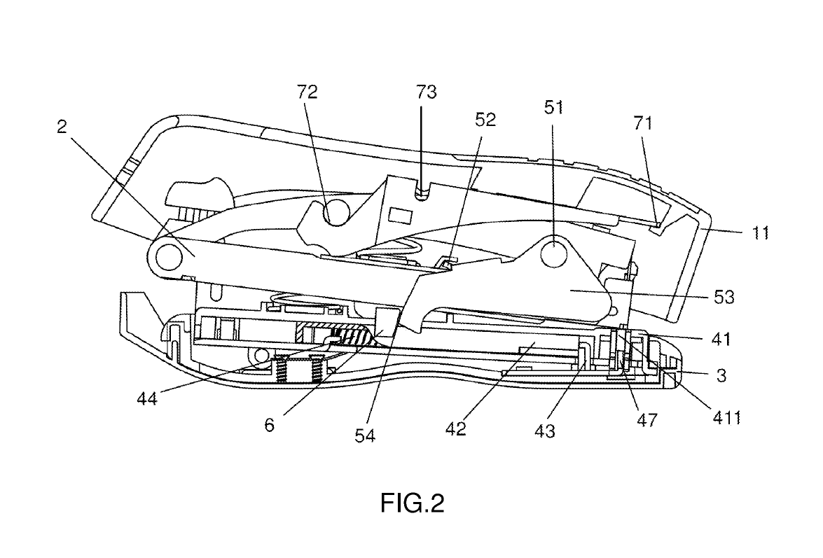

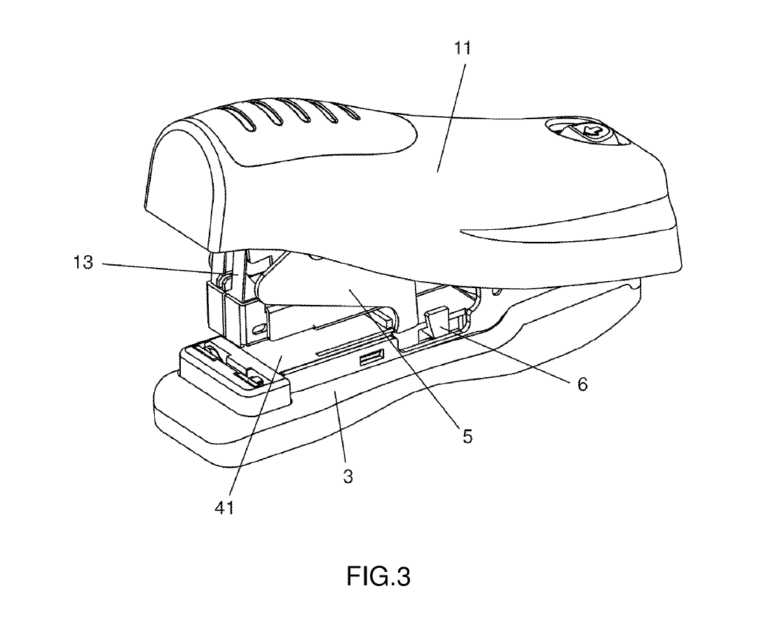

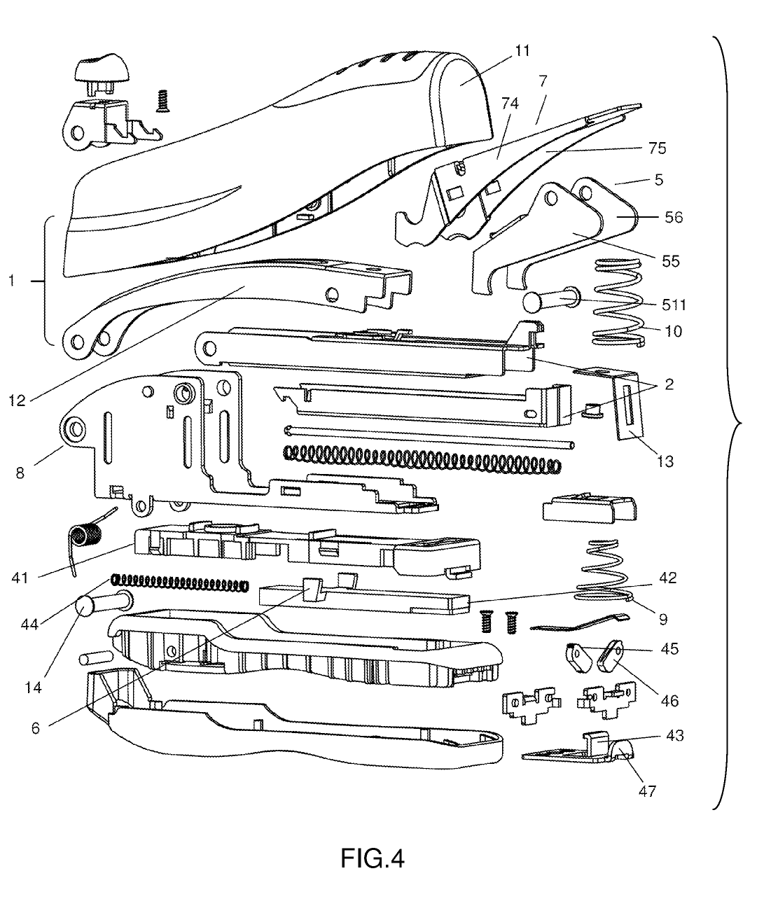

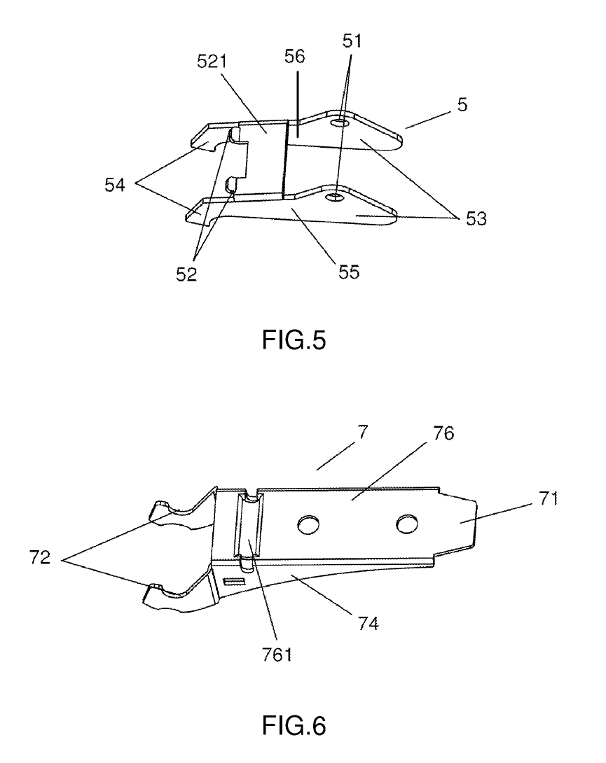

As shown in FIG. 1 to FIG. 6, the flat-clinch stapler according to the present embodiment comprises a staple pressing device 1, a staple magazine device 2, a base 3, a staple flat-clinching device 4, a push arm 5, a sliding block 6, an effort saving arm 7 and a hanger 8.

The staple flat-clinching device 4 comprises a movable platform 41 upwardly biased, vertically movable and accommodated in the base 3, a movable platform supporting block 42, a movable platform position fixing block 43 fixedly provided in the base 3 placing above the movable platform supporting block 42 during a stationary condition to lift up the movable platform 41, and a spring 44 which biases the movable platform supporting block 42 forward. The staple flat-clinching device 4 also comprises a left staple bending member 45, a right staple bending member 46 and a staple bending member stopper 47. The staple bending member stopper 47 is fixedly provided in the base 3 and it corresponds to the position of a staple plunge hole 21 of the staple magazine device 2 and the position of a staple slot 411 of the movable platform 41. Outer ends of the left staple bending member 45 and the right staple bending member 46 respectively are structured to be pivotally rotable and they are pushed to rotate pivotally upward by the staple bending member stopper 47 during the process of staple clinching to form a plane for flattening ends of a staple.

The push arm 5 comprises an upper fulcrum 51 pivotally connected with the staple pressing device 1, a middle fulcrum 52 pivotally connected with the staple magazine device 2, a blocking part 53 provided at a front end of the push arm 5 covering the spaces between the staple pressing device 1 and the staple magazine device 2, and a lower push arm 54. While clinching a staple, the lower push arm 54 contacts the sliding block 6 of the movable platform supporting block 42 and pushes it backward so that the movable platform supporting block 42 is pushed to separate from the movable platform position fixing block 43 and thereby allowing the movable platform 41 to press downward to complete flat clinching of a staple. The push arm 5 comprises a left side panel 55 and a right side panel 56 provided on a left side and a right side of the staple magazine device 2 respectively. The left side panel 55 and the right side panel 56 are mutually connected with each other at the upper fulcrum of the push arm 5 via a first pivot pin 511 and they are also pivotally connected with the staple pressing device 1. The left side panel 55 and the right side panel 56 are mutually connected with each other at the middle fulcrum 52 of the push arm 5 via a second connecting member 521. A rear end of the second connecting member 521 is disposed with a pivotal connection structure which is pivotally connected with the staple magazine device 2.

The staple pressing device 1 comprises an outer cap 11, an inner cap 12 disposed inside the outer cap 11, and a staple plunger blade 13 disposed at a front end of the inner cap 12. A rear end of the inner cap 12 is pivotally connected with a rear end of the staple magazine device 2 via a third pivot pin 14. The hanger 8 is fixedly provided between the outer cap 11 and the base 3. A rear part of the inner cap 12 is pivotally connected with a rear part of the hanger 8.

The effort-saving arm 7 comprises a force exertion point 71 connected with an inner side of a front end of the outer cap 11 at its one end, a supporting point 72 pivotally connected with the hanger 8 at the other end, and a pressing point 73 pivotally connected with an upper side of the inner cap 12 between the force exertion point 71 and the supporting point 72. Ratio of distance between the third pivot pin 14 and the pressing point 73 and distance between the third pivot pin 14 and the front end of the inner cap 12 is greater than ratio of distance between the supporting point 72 and the pressing point 73 and distance between the supporting point 72 and the force exertion point 71. The effort-saving arm 7 comprises a left side plate 74 and a right side plate 75 disposed on a left side and a right side of the inner cap 12 respectively. The left side plate 74 and the right side plate 75 are connected by an upper side plate 76 across their upper parts. A curved groove 761 rotable on an upper surface of the inner cap 12 is disposed on an inner side of the upper side plate 76 at the pressing point 73.

The present invention is operated as follows:

When the flat-clinch stapler is stationary, the movable platform supporting block 42 is placed above the movable platform position fixing block 43 and the movable platform 41 is lifted up.

In the beginning of clinching a staple, a front end of the outer cap 11 of the staple pressing device 1 is pressed down and the force exertion point 71 of the effort-saving arm 7 is thereby driven to be pressed down; the supporting point 72 of the effort-saving arm 7 is then driven to rotate pivotally and the pressing point 73 is then driven to press down the inner cap 12; the staple plunger blade 13 is then driven to be pressed down to drive a staple at the forefront of the staple magazine device 2 out from the staple plunge hole 21; meanwhile, the upper fulcrum 51 of the push arm 5 rotates pivotally along the first pivot pin 511 and the middle fulcrum 52 rotates pivotally along the pivotal connection structure of the second connecting member 521 while the lower push arm 54 is pushed backward to contact the sliding block 6 and then pushes the sliding block 6 backward; accordingly, the movable platform supporting block 42 is simultaneously driven to be pushed backward until the movable platform supporting block 42 separates from the movable platform position fixing block 43; at this time, the force of downward pressing exerted by user causes the movable platform 41 to move down into the base 3, and the staple bending member stopper 47 pushes the left staple bending member 45 and the right staple bending member 46 to rotate pivotally upward to form a plane for flattening ends of the staple and ends of the staple are then pressed against that plane to complete flat-clinching of the staple.

After clinching the staple, user stops to exert force onto the stapler and the movable platform 41 returns to its upwardly biased position; the staple magazine device 2 is pushed upward by a first reset device 9 disposed between the movable platform 41 and the staple magazine device 2 and thereby returns to its original position while the inner cap 12 is also pushed upward by a second reset device 10 disposed between the inner cap 12 and the staple magazine device 2 and thereby returns to its original position; the upper fulcrum 51 of the push arm 5 then rotates pivotally along the first pivot pin 511 and the middle fulcrum 52 also rotates pivotally along the pivotal connection structure of the second connecting member 521 such that the lower push arm 54 is driven to move forward; since the force that pushes the sliding block 6 backward disappears, the movable platform supporting block 42 is pushed forward by the spring 44 to returns to its original position and again placed above the movable platform position fixing block 43 to prevent the movable platform 41 from moving downward.

The above embodiment is a more preferred description of the present invention. However, description of the present invention is not limited by the above embodiment. Any other changes, modification, substitution, combinations and simplification not deviated from the spiritual essence and principle of the present invention are equivalent replacement and they all fall into the scope of protection of the present invention.

What is claimed is:

1. A kind of flat-clinch stapler comprising a staple pressing device, a staple magazine device, a base and a staple flat-clinching device whereas the staple flat-clinching device comprises a movable platform upwardly biased, vertically movable and accommodated in the base, a movable platform supporting block, a movable platform position fixing block fixedly provided in the base placing above the movable platform supporting block during a stationary condition to lift up the movable platform, and a spring which biases the movable platform supporting block forward; and characterized in that it also comprises a push arm whereas the push arm comprises an upper fulcrum pivotally connected with the staple pressing device, a middle fulcrum pivotally connected with the staple magazine device, a blocking part provided at a front end of the push arm covering the spaces between the staple pressing device and the staple magazine device, and a lower push arm whereas the lower push arm, while clinching a staple, contacts the sliding block of the movable platform supporting block and pushes it backward so that the movable platform supporting block is pushed to separate from the movable platform position fixing block and thereby allowing the movable platform to press downward to complete flat clinching of a staple.

2. The flat-clinch stapler as in claim 1, characterized in that, the push arm comprises a left side panel and a right side panel provided on a left side and a right side of the staple magazine device respectively.

3. The flat-clinch stapler as in claim 2, characterized in that, the left side panel and the right side panel are mutually connected with each other at the upper fulcrum of the push arm via a first pivot pin and they are also pivotally connected with the staple pressing device.

4. The flat-clinch stapler as in claim 2, characterized in that, the left side panel and the right side panel are mutually connected with each other at the middle fulcrum of the push arm via a second connecting member; a rear end of the second connecting member is disposed with a pivotal connection structure which is pivotally connected with the staple magazine device.

5. The flat-clinch stapler as in claim 1, characterized in that, the staple pressing device comprises an outer cap, an inner cap disposed inside the outer cap, and a staple plunger blade disposed at a front end of the inner cap; a rear end of the inner cap is pivotally connected with a rear end of the staple magazine device via a third pivot pin.

6. The flat-clinch stapler as in claim 5, characterized in that, it also comprises an effort-saving arm and a hanger whereas the hanger is fixedly provided between the outer cap and the base; a rear part of the inner cap is pivotally connected with a rear part of the hanger; the effort-saving arm comprises a force exertion point connected with an inner side of a front end of the outer cap at its one end, a supporting point pivotally connected with the hanger at the other end, and a pressing point pivotally connected with an upper side of the inner cap between the force exertion point and the supporting point; and ratio of distance between the third pivot pin and the pressing point and distance between the third pivot pin and the front end of the inner cap is greater than ratio of distance between the supporting point and the pressing point and distance between the supporting point and the force exertion point.

7. The flat-clinch stapler as in claim 6, characterized in that, the effort-saving arm comprises a left side plate and a right side plate disposed on a left side and a right side of the inner cap respectively; the left side plate and the right side plate are connected by an upper side plate across their upper parts; a curved groove rotable on an upper surface of the inner cap is disposed on an inner side of the upper side plate at the pressing point.

8. The flat-clinch stapler as in claim 1, characterized in that, the staple flat-clinching device also comprises a left staple bending member, a right staple bending member and a staple bending member stopper; the staple bending member stopper is fixedly provided in the base and it corresponds to the position of a staple plunge hole of the staple magazine device and the position of a staple slot of the movable platform; outer ends of the left staple bending member and the right staple bending member respectively are structured to be pivotally rotable and they are pushed to rotate pivotally upward by the staple bending member stopper during the process of staple clinching to form a plane for flattening ends of a staple.
